(19) United States
(12) Patent Application Publication
(10) Pub. No.: US 2009/0148553 A1
(43) Pub. Date: Jun. 11, 2009

(54) Mold apparatus

(75) Inventors: Hisashi Sawada, Okazaki-city (JP); Shuichi Tamaki, Nishio-city (JP); Yukinori Narita, Toyokawa-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/316,025

(22) Filed: Dec. 9, 2008

(30) Foreign Application Priority Data
Dec. 11, 2007 (JP) 2007-319932

(51) Int. Cl. B29C 45/04

(52) U.S. Cl. 425/575

(57) ABSTRACT

A mold apparatus for two-color molding enabling the use of a general-use mold apparatus with a short support sprue and simple structure, having a fixed side mold, a movable side mold freely openable and closable with respect to the fixed side mold, and a movable partitioning member which is arranged at least at one of the fixed side mold and the movable side mold and partitions a space for molding two types of thermoplastic resin into a first space for molding a first thermoplastic resin and a second space for molding a second thermoplastic resin, wherein a compact injection molding unit injecting the first thermoplastic resin is built-in, and a nozzle of a compact injection molding unit is made to directly adjoin the first space.

### BACKGROUND OF THE PRESENT INVENTION

1. Field of the Invention

The present invention relates to a mold apparatus which integrally molds two types of thermoplastic resins to produce a two-color shaped article, more particularly relates to a mold apparatus for a shaped article comprised of a main part and packing part which molds the main part by a second thermoplastic resin and molds the packing part by a first thermoplastic resin.

2. Description of the Related Art

When it is necessary due to the demands for physical properties or design to mold one article from a plurality of types of resins or a plurality of the same type of resin having different colors, the two-color molding method has been employed in the past. This two-color molding method first injects a first molten resin into a first cavity to mold a first resin part, then injects a second molten resin into the second cavity adjacent to the first cavity to mold a second resin part. By doing so, the first resin part and the second resin part are melt bonded together whereby an integrated two-color shaped article is molded.

With this two-color molding method, it is necessary to partition the first cavity and the second cavity so as to limit the flow of the first molten resin to the second cavity. As this method, when using a plurality of different molds, there is the method of partitioning the molds themselves, but when using one type of mold, as described in Japanese Patent Publication (A) No. 11-48284, partitioning by a slide core (movable partitioning member) is often used.

The method of using one type of mold is better in production efficiency than the method of using a plurality of different molds. However, there is a problem that instead of a general-use injection molding machine provided with one injection unit, it is necessary to separately prepare a dedicated injection molding machine provided with two injection units, so the capital costs rise. As a countermeasure, there is the mold for injection molding which is set in a general-use injection molding machine provided with one injection unit and can perform two-color molding in one process described in Japanese Patent Publication (A) No. 6-87138. This is shown in FIG. 10 and FIG. 11.

As shown in FIG. 10, this mold 80 is provided with a main sprue (not shown) communicating with a main gate (not shown), a support sprue 83 communicating to a support gate 82, and a compact plunger type injection unit 90.

At the front of the support gate 82, a movable member 84 is provided in a manner able to advance and retract freely to and from a cavity 85 using a cylinder apparatus 86. The plunger type injection unit 90 has an injection port which is connected to the support sprue 83 and is fixed integrally to a side surface of a main body 81. Further, the plunger type injection unit 90, as shown in FIG. 11, is connected to a hopper 91 for feed of the first resin material through a transparent flexible hose 92 serving as the feed path.

In FIG. 10, 81 is an injection unit provided in a general use injection apparatus (not shown), and 89 is a heater. In FIG. 11, 94 is a plunger, and 93 is a molding material. If the mold 80 of the aforementioned configuration is set so that the tip of the injection unit 81 of the general-use injection molding machine (not shown) approaches the main sprue, two-color molding can be performed.

However, in this structure, the support sprue 83 is long, and a heater 89 has to be arranged for this support sprue, so the mold structure becomes complex. Further, the support sprue is taken out together with the shaped article and is cut off from the final product, so there is a tremendous waste of material compared to the considerable amount of the packing part required in the final product.

### SUMMARY OF THE PRESENT INVENTION

The present invention was made in consideration of the above problem and has as its object to provide a mold apparatus for two-color molding which enables the use of a general-use injection molding machine with a short support sprue and a simple mold structure.

The present invention provides, as a means for solving the aforementioned problem, the following aspects of a mold apparatus. According to a first aspect of the present invention, a mold apparatus (100) has a built-in compact injection molding unit (5) injecting a first thermoplastic resin and makes a nozzle (5a) of the compact injection molding unit (5) directly adjoin a first space (11a) for molding a first thermoplastic resin.

By providing a built-in compact injection molding unit (5) injecting a first thermoplastic resin, the entire mold apparatus becomes compact. Further, as the nozzle (5a) of the compact injection molding unit is made to directly adjoin the first space (11) for molding the first thermoplastic resin, the support sprue is eliminated and the waste of material is eliminated. Further, as the support sprue is eliminated, the heater arranged around the support sprue becomes unnecessary, so the mold apparatus becomes simpler.

According to a second aspect of the present invention, the first thermoplastic resin is a soft resin, the second thermoplastic resin is a hard resin, a two-color shaped article (50) is comprised of a main part (51) and packing part (52), the main part (51) is made from the second thermoplastic resin, and the packing part (52) is made from the first thermoplastic resin.

Conventionally, the main body was molded from a resin and assembled with a separately fabricated packing to form the finished product. By integrally molding the main body and the packing, the quality control costs, assembly costs, and maintenance and management costs can be reduced. Further, if applying the present invention to a two-color shaped article molding the main part by the second thermoplastic resin and molding the packing part by the first thermoplastic resin, the effects of the present invention become more remarkable.

According to a third aspect of the present invention, there is provided a mold apparatus for integral molding a plurality of types of thermoplastic resins to produce a multi-color shaped article characterized by including a mold apparatus (100) of the first or second aspect. This clarifies that the two-color molding mold of the present invention can be applied to multi-color molding. Note the numerals in parentheses after the means described in the claims and this section show the correspondence with specific means described in the later-mentioned embodiments.

### BRIEF DESCRIPTION OF THE DRAWINGS

These and other objects and features of the present invention will become clearer from the following description of the preferred embodiments given with reference to the attached drawings, wherein:

FIG. 1 is a view showing a process time chart of a molding method using the mold apparatus of the present invention;

FIG. 2 is a view showing the state of the mold apparatus in a shaped article takeout step and a closed first space forming step using the mold apparatus of the first embodiment of the present invention;

FIG. 3 is a view showing the state of the mold apparatus in a shaped article takeout step and a first resin injection step using the mold apparatus of the first embodiment of the present invention;

FIG. 4 is a view showing the state of the mold apparatus in a mold closing step and a first and second space communication step using the mold apparatus of the first embodiment of the present invention;

FIG. 5 is a view showing the state of the mold apparatus in a second resin injection step using the mold apparatus of the first embodiment of the present invention;

FIG. 6 is a view showing a two-color shaped article molded in the first embodiment of the present invention;

FIG. 7 gives views for explaining movement of a cavity partitioning member of the first embodiment of the present invention;

FIG. 8 is a cross-sectional view of a compact injection molding unit of the first embodiment of the present invention;

FIG. 9 shows a scroll forming part of the compact injection molding unit of FIG. 8, wherein (a) is a perspective view showing the scroll working surface 47, and (b) is a cross-sectional view along the arrow A-A in (a);

FIG. 10 shows a conventional mold apparatus; and

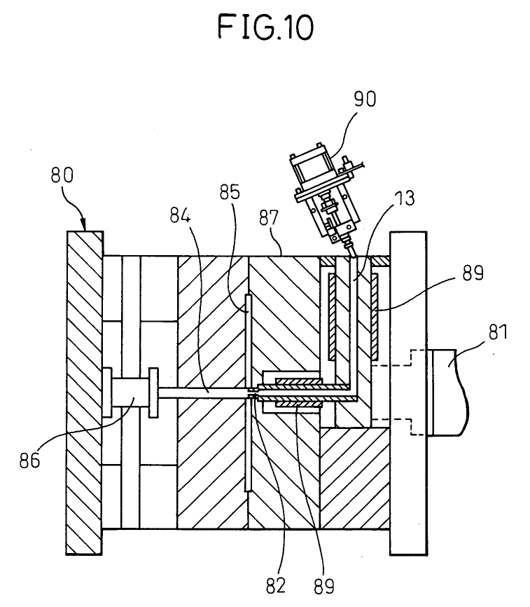

FIG. 11 is an enlarged view of FIG. 10,

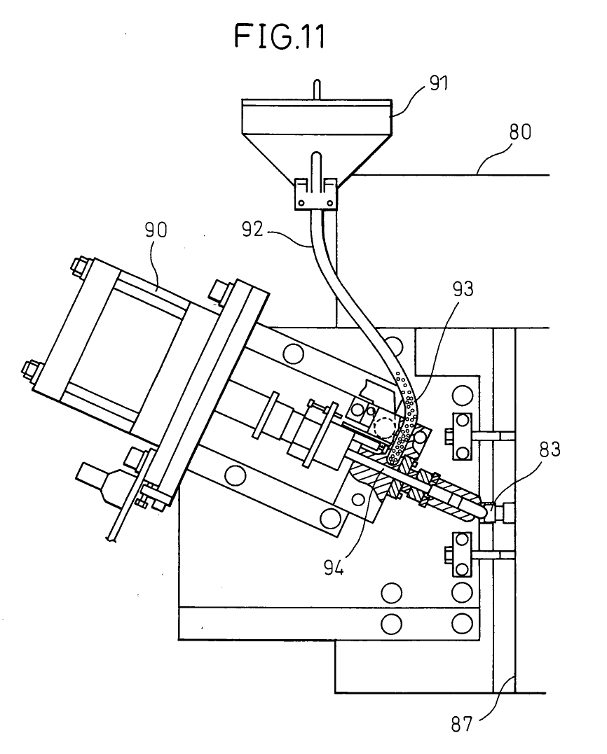

wherein 1 indicates a fixed side mold, 2 a movable side mold, 3 a movable cavity partitioning member, 4 an injection nozzle, 5 a compact injection molding unit, 5a a nozzle of a compact injection molding unit, 6 a shaft, 11 a cavity, 50 a two-color shaped article of the first embodiment, and 100 a mold apparatus of the first embodiment.

### DESCRIPTION OF THE PREFERRED EMBODIMENTS

Below, an embodiment of the present invention will be described based on the drawings.

### First Embodiment

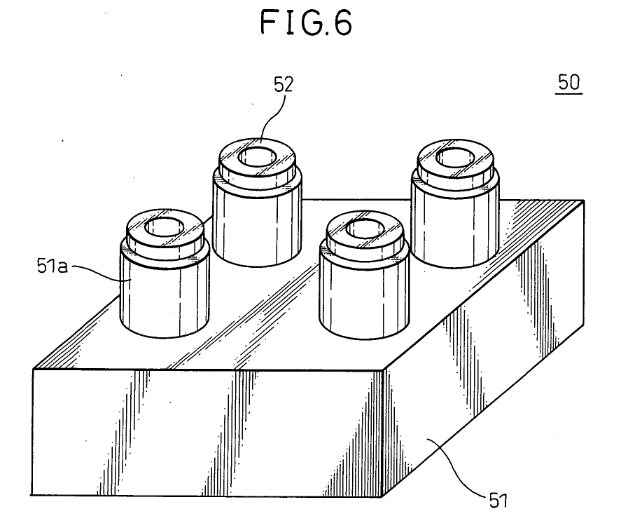

First, a first embodiment of the present invention will be explained. The first embodiment is a mold apparatus 100 using a movable cavity partitioning member partitioning a cavity formed by a fixed side mold and movable side mold into a first space and second space (hereinafter, simply referred to as a “cavity partitioning member”). FIG. 6 is a schematic view showing a two-color shaped article 50 molded by the first embodiment. The two-color shaped article 50 is comprised of a main part 51 and packing part 52. The main part 51 has a rectangular shape having four boss parts 51a. At each cylindrical boss part 51a, a donut-shaped packing part or seal part (hereinafter simply referred to as a “packing part”) 52 is melt bonded to be formed integral with it. The main part 51 (including the boss parts 51a) is made by a hard resin (second resin), for example, a general-use resin polypropylene, and the packing part 52 is made by a soft resin (first resin), for example, an elastomer.

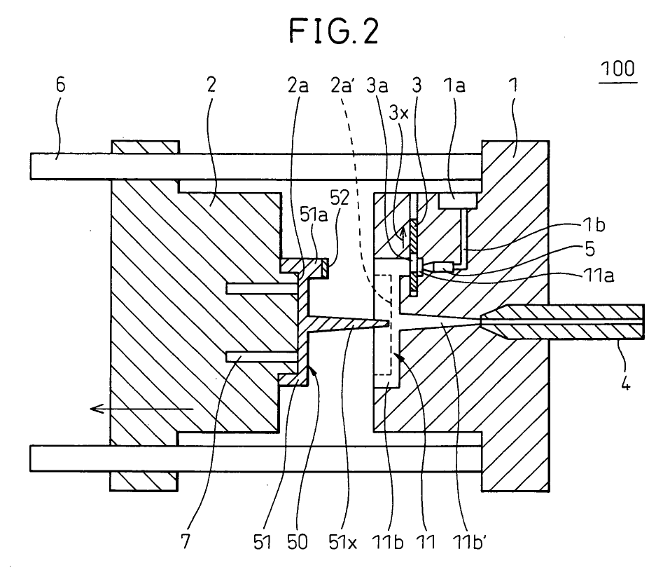

Further, FIG. 6 shows a two-color shaped article from which a sprue 51x (see FIG. 2) molded by a resin passage is cut off. The two-color shaped article 50 may be, for example, a vehicular air-conditioner part or any other case, cover, or other product. Of course, the main part does not have to include the boss parts and may have a shape that is not rectangular but cylindrical or the shape of a spiral casing or the like. Further, the packing part is not limited to a donut shape and may be rectangular or any other shape.

Next, a mold apparatus 100 of the first embodiment will be described based on FIG. 2. FIG. 2 is a view showing the state of a mold apparatus 100 in a shaped article takeout step and a closed first space forming step of the first embodiment. The mold apparatus 100 has a fixed side mold 1, a movable side mold 2 freely openable and closable with respect to the fixed side mold 1, and a cavity partitioning member 3 arranged at the fixed side mold 1 and partitioning a cavity 11 formed by the fixed side mold 1 and the movable side mold 2 into a first space 11a and second space 11b. The cavity partitioning member 3 may be arranged at the movable side mold 2 as well. The fixed side mold 1 and movable side mold 2 are supported by a shaft 6 provided at a polypropylene injection molding machine that injection molds polypropylene (second resin). The fixed side mold 1 is fixed to the shaft 6, while the movable side mold 2 guides the shaft 6 to move in a straight line in a slidable fashion to open or close the mold.

The fixed side mold 1 has an injection nozzle 4 of the second resin injection molding machine inserted into it at its center part. Polypropylene (second resin) is injected from the injection nozzle 4. Further, the fixed side mold 1 is provided with a compact injection molding unit (first resin injection molding unit) 5, a hopper 1a holding an elastomer material, and a transport path 1b transporting the elastomer material from hopper 1a to the compact injection molding unit 5. The compact injection molding unit 5 is an apparatus for injecting the elastomer (first resin), has the functions of plasticizing, weighing, and feeding the elastomer, and is built in the mold.

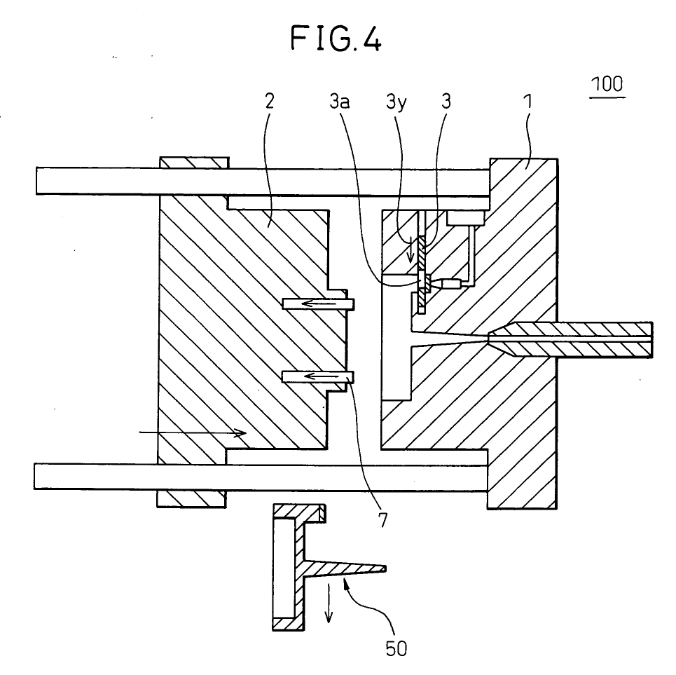

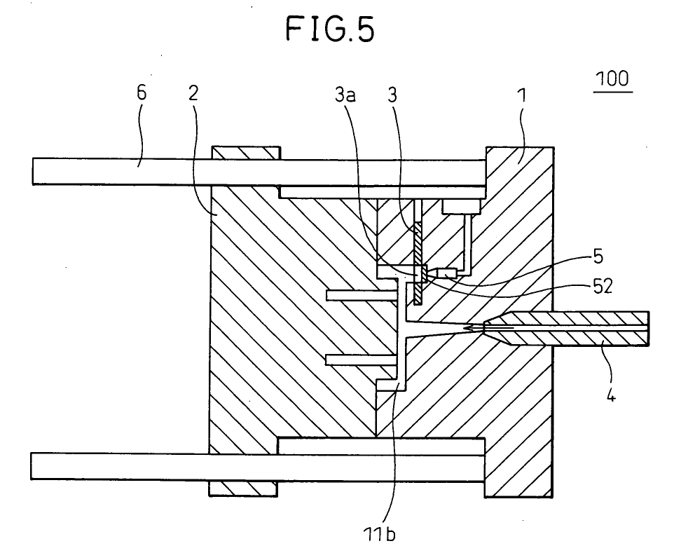

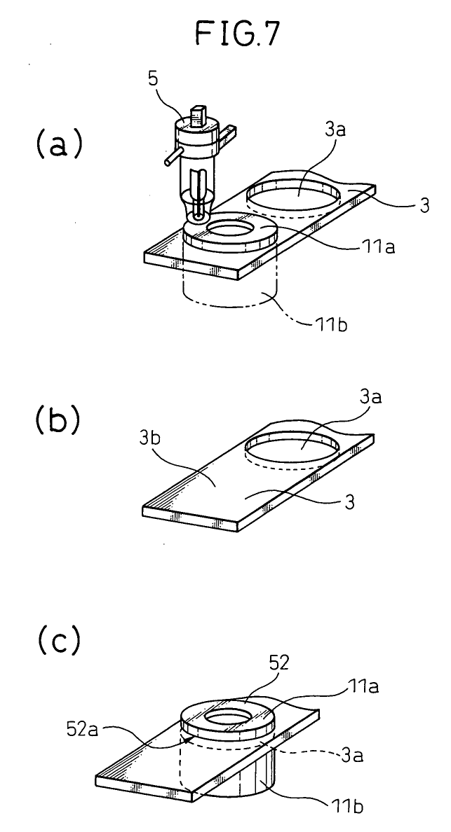

Between the fixed side mold 1 and the movable side mold 2 is formed a space for molding the resin, that is, a cavity 11. Note that the dotted line 2a′ of FIG. 2 shows the surface 2a of the movable side mold 2 when the movable side mold 2 is clamped (the mold is closed) (see FIG. 5). The fixed side mold 1 is provided with the cavity partitioning member 3 (see FIG. 7) in a manner enabling it to freely advance and retract. The cavity partitioning member 3 retracts (arrow 3x of FIG. 2) to partition the cavity 11 into the first space 11a and the second space 11b. Further, it advances (arrow 3y of FIG. 4) to communicate and open the first space 11a and second space 11b partitioned by this through the hole 3a of the cavity partitioning member 3 to return to the original cavity 11 state. The first space 11a is a space filled by injection of the elastomer, while the second space 11b is a space filled by injection of polypropylene. The second space 11b includes a sprue 11b′ of the molten resin passage. Note that the boundary between the first space 11a and second space 11b is shown by the dotted line 2a′ in FIG. 2.

The movement of the cavity partitioning member 3 will be explained with reference to FIG. 7. FIG. 7 gives views showing the internal structure of the mold. FIG. 7(a) shows the relationship among the cavity partitioning member 3, the compact injection molding unit 5, and the mold cavity 11 when the cavity partitioning member 3 is in a retracted state. FIG. 7(b) shows only the cavity partitioning member 3. The cavity partitioning member 3 is provided with a hole 3a of the same diameter as the boss parts 51a of the shaped article 50. Due to the retracted state of the cavity partitioning member 3 shown in FIG. 7(a), the cavity 11 is partitioned into the first space 11a and second space 11b via the flat part (no hole) 3b of the cavity partitioning member 3. FIG. 7(c) is a view showing the relationship among the cavity partitioning member 3, the hole 3a of the cavity partitioning member 3, and the mold cavity 11 when the cavity partitioning member 3 is in the advanced state. The position of the compact injection molding unit 5 is the same as the position in FIG. 7(a). Due to the advanced state of the cavity partitioning member 3, the partitioned first space 11a and second space 11b are communicated and opened through the hole 3a and returned to the original cavity 11. In the hole 3a, a connecting part 51a with a packing part 52 in the main part 51 can be formed. The hole 3a may be formed to any shape, so the connecting part 51a to which the hole shape is transferred may also be formed to any shape. Due to this, the movable partitioning member 3 can be used even when the first cavity 11a and the second cavity 11b have completely different shapes and when their connecting part 51a has a non-simple shape.

The movable side mold 2 has the shaped article 50 stuck to it immediately after being molded. In FIG. 2, for simplification, of the normally four packing parts 52 and boss parts 51a, only one each is shown. The rest are omitted. Further, in the shaped article 50, a sprue 51x molded in the resin passage 11b′ is formed. This sprue 51x is not necessary in the final product, so is cut off and disposed of after being taken out from the mold. The movable side mold 2 is provided with a plurality of ejector pins 7 for detaching the shaped article 50 from the movable side mold 2.

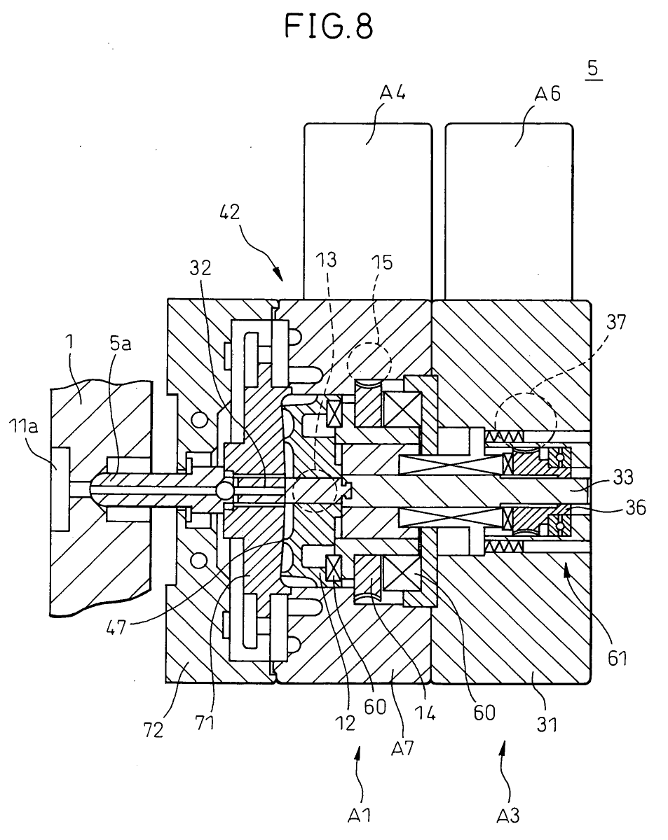

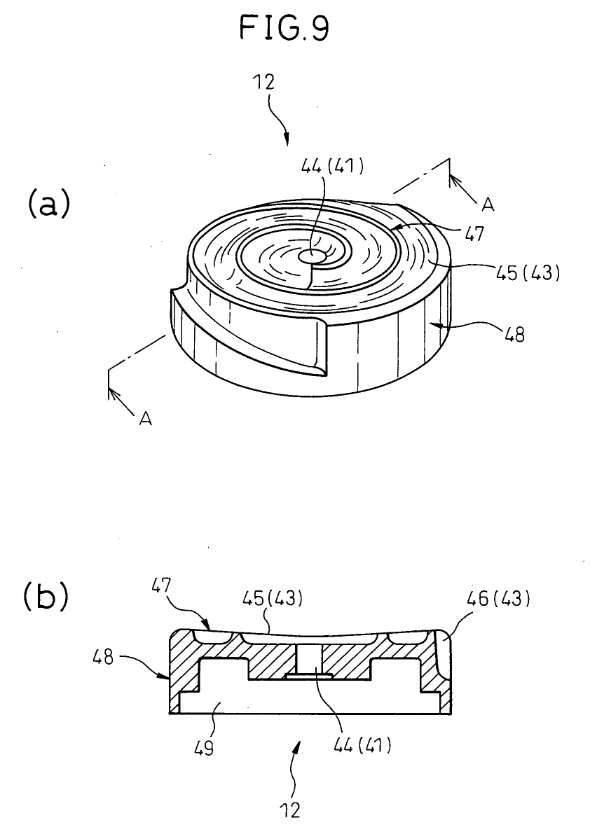

Here, the compact injection molding unit 5 will be described in detail based on FIG. 8 and FIG. 9. The compact injection molding unit 5 is a molding unit as described in Japanese Patent Publication (A) No. 2005-306028. The compact injection molding unit 5 has a nozzle 5a arranged in the mold 1 directly adjacent to the first space 11a of the mold 1. Since the nozzle 5a of the compact injection molding unit 5 is made to directly adjoin the first space 11a for molding the first thermoplastic resin, the support sprue is eliminated. Due to this, the heater arranged surrounding the support sprue is not necessary either, so the mold apparatus becomes simplified.

The compact injection molding unit 5 has a plasticizing part A1 provided with a plasticizing block A7 in which is provided a plasticizing and force-feeding mechanism which heats and plasticizes the material and force-feeds it while kneading it and a weighing and injecting part A3 provided with a weighing block 31 connected closely with the plasticizing block A7 and provided inside it with a weighing and feeding mechanism which weighs and feeds the material force-fed by the plasticizing and force-feeding mechanism. Further, the injection molding machine is provided with a fixed plate 72 provided inside it with an injection mechanism which injects the material weighed and fed by the weighing and feeding mechanism into the cavity.

At a side surface of the plasticizing block A7, a material charging hole 13 through which pellets or another material is charged is formed. Further, inside the plasticizing block A7, a plasticizing and force-feeding mechanism (kneading mechanism) is provided. This plasticizing and force-feeding mechanism is provided with a barrel 71 which heats the material charged from the material charging hole 13, a scroll 12 formed with a spiral groove 43 which conveys the material and rotating while abutting against the barrel 71 whereby the material is conveyed, agitated, plasticized, kneaded while being heated and, after plasticizing, force-fed to a scroll axial bore 44 formed at its center of rotation, and a scroll drive part 42 which drives the scroll 12 to rotate.

The scroll 12 is a rotary body forming a substantially short columnar shape as shown in FIG. 9 and is formed with the spiral groove 43 from a side surface of the rotary body to a surface on a fixed die plate 72 side. The spiral groove 43 is formed to be reduced in a rotational direction of the scroll 12 up to near the scroll axial bore 44 through which the injection plunger 32 formed at a rotary shaft is inserted, and a drive part engaging groove 49 formed in a concave shape is formed in its back surface. Note that the scroll axial bore 44 is also used as an injection cylinder 41.

Below, the surface on the fixed plate 72 side is referred to as a scroll working surface 47, and its side surface is referred to as a scroll side surface 48. Further, FIG. 9(a) is a perspective view overlooking the scroll working surface 47, while FIG. 9(b) is a sectional view seen along the arrow A-A of FIG. 9(a).

The scroll working surface 47 and the barrel 71 are configured to be in close contact with each other so that the material plasticized by heat from the barrel 71 does not leak out of the feeding groove 45, and the material is force-fed toward the scroll axial bore 44 along the feeding groove 45.

The scroll drive part 42 has a worm wheel 14 which attachably and detachably engages with the scroll 12 via a heat insulator, a worm gear 15 meshed with the worm wheel 14, a motor 4 which rotates the worm gear 15, a thrust bearing 60, and the like.

As the motor 4 rotates, its rotational speed is transmitted to the scroll 12 while being reduced by the worm wheel 14 and the worm gear 15 and rotates the scroll 12.

The injection cylinder 41 which communicates with the scroll axial bore 44 is formed in the center of the barrel 71, and the injection plunger 32 is inserted into the injection cylinder 41 and performs piston movement. Further, the injection plunger 32 is inserted into the injection cylinders 39 and 41 and is provided at its tip with a nozzle 5a protruding out to the mold 1 side.

The weighing block 31 in the weighing and injecting part A3 is provided with the weighing and feeding mechanism which weighs the material and feeds it to the mold part 2 via the nozzle 5a. The weighing and feeding mechanism has the injection plunger 32 which penetrates through the scroll axial bore 44 of the scroll 12 and the like, a plunger use ball screw 33 which attachably and detachably engages with the injection plunger 32, and a plunger drive part 61 which weighs and feeds out the material force-fed to the injection plunger 32 by causing the injection plunger 32 to perform a piston movement by driving the plunger use ball screw 33.

The plunger drive part 61 has a motor 6, a worm gear 37 which obtains rotational power from the motor 6, and a worm wheel 36 which is meshed with the worm gear 37 to reduce the speed of the motor 6 and transmit it to the plunger use ball screw 33 and thereby causes the injection plunger 32 attachably and detachably engaged with the plunger use ball screw 33 to perform piston movement.

The reason why the compact injection molding unit 5 is made much more compact than a usual injection molding unit is that it employs a scroll instead of the conventional helical screw type having a long axial direction used for agitation, plasticization, and kneading and employs a mechanism capable of large deceleration by using a worm wheel etc.

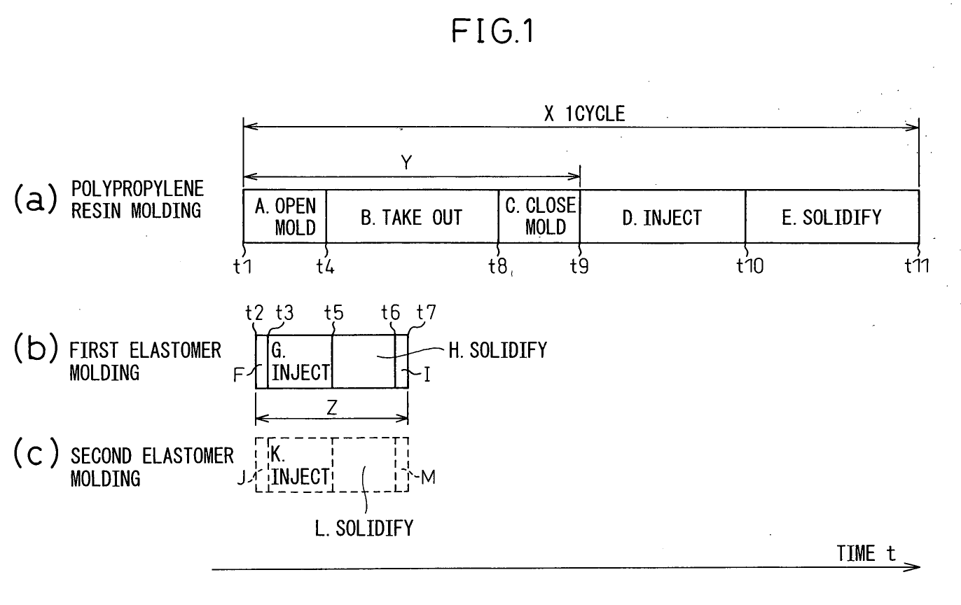

Next, based on FIG. 1, the process for molding a two-color shaped article using the mold apparatus of the first embodiment will be described. FIG. 1 is a view showing time charts of the molding process. (a) is a time chart showing a molding step of a polypropylene resin, (b) showing a molding step of the first elastomer, and (c) showing a molding step of the second elastomer in units of time on the horizontal axis. (a), (b), and (c) are each shown by the same time axis.

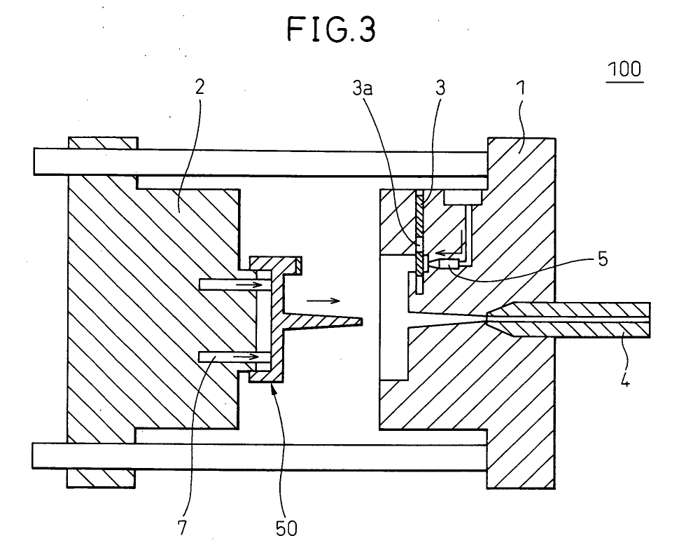

First, the steps of (a) and (b) will be explained. At the time t1, the movable side mold 2 begins to open from the state where it is clamped to the fixed side mold 1 (see FIG. 5). Due to the hydraulic pressure drive apparatus (not shown) of the injection molding machine, the movable side mold 2 is guided by the shaft 6 and moved to the left direction (see FIG. 2). The state where the movement of the movable side mold 2 is halted is shown in FIG. 2. At the time t2 where some time has passed since the movable side mold 2 began opening, the cavity partitioning member 3 begins moving upward (arrow 3x direction in FIG. 2). At the time t3, the cavity partitioning member 3 finishes its movement upward whereby the cavity 11 is partitioned into the first space 11a and the second space 11b, and the second space 11b is completely shut off from the first space 11a (see FIG. 3). The period from the time t2 to the time t3 becomes the closed first space forming steps F and J.

At the time t3, the cavity partitioning member 3 finishes its upward movement, whereby the compact injection molding unit 5 begins injection of the molten first elastomer. At the time t5, the first elastomer finishes being injected. The period from the time t3 to the time t5 becomes the first resin injection steps G and K. At the time t5, the molten first elastomer is cooled by the mold 1, and at time t6, solidification of the first elastomer is finished. The period from the time t5 to the time t6 becomes the first resin solidification steps H and L. At the time t6, the cavity partitioning member 3 begins to move downward (the arrow 3y direction in FIG. 4). At the time t7, the cavity partitioning member 3 finishes moving downward, whereby the partitioned first space 11a and second space 11b form the cavity 11 by communicating through the hole 3a of the cavity partitioning member 3 (see FIG. 5). The period from the time t6 to the time t7 becomes the first and second space communication steps I and M.

On the other hand, at the time t4 where some time has passed since the time t3 where the cavity partitioning member 3 finishes moving upward, the leftward movement of the movable side mold 2 is finished and the movable side mold 2 is completely open in state (see FIG. 3). When the movable side mold 2 is in an open state, the ejector pins 7 begin protruding toward the two-color shaped article 50 formed in the previous shaping cycle and stuck to the movable side mold 2. At the time t8, the protruding lengths of the ejector pins 7 become the maximum and the two-color shaped article 50 detaches from the movable side mold 2. The period from the time t1 to the time t8 becomes the shaped article takeout steps A and B. Further, the protrusion from the ejector pins 7 may begin before the movable side mold 2 finishes opening. At the time t8 where the two-color shaped article 50 is detached, the movable side mold 2 begins moving rightward and begins to close the mold. In parallel with this, the ejector pins 7 begin retracting towards their original positions.

At the time t9, the movable side mold 2 is closed and clamped to the fixed side mold 1 (see FIG. 5). The period from the time t8 to the time t9 becomes the mold closing step C.

At the time t9, when the mold is closed, the molten polypropylene resin is injected from the injection nozzle 4 of the injection molding machine (not shown). The first elastomer filled in the first space 11a melt bonds with the molten polypropylene at the end face 52a (see FIG. 7(c)). At the time t10, the polypropylene finishes being injected. The period from the time t9 to the time t10 becomes the second resin injection step D. In the period from the time t10 to the time t11, the molten polypropylene resin is cooled and solidified by the mold. The period from the time t10 to the time t11 becomes the second resin solidification step E. By doing this, the two-color shaped article 50 integrally molded from the first resin (first elastomer) and the second resin (PP) is molded. At the time t11, when the polypropylene finishes being solidified, one cycle of molding is completed. The next molding cycle begins again at the time t1. By doing this, the steps from the time t1 to the time t11 are repeated, whereby the shaped article 50 is manufactured in large quantities.

In the molding process, the shaped article takeout steps (A and B), mold closing step C, closed first space forming step F, first resin injection step G, first resin solidification step H, and first and second space communication step I proceed in parallel; the closed first space forming step F begins after the time t1 where the shaped article takeout step is started; and the mold closing step C is finished after the time t7 where the first and second space communication step is finished.

That is, by performing the elastomer molding step using the time Z from the time t2 to the time t7 in the range of the time period Y needed for the shaped article takeout step and mold closing step from the time t1 to the time t9, the time of the shaped article takeout step and mold closing step which was not actively used at all in the past can be used effectively for the molding process. By this, the molding time X of 1 cycle can be reduced.

In the above description, the molding of only one first resin (elastomer) coupled with the molding of the second resin (polypropylene) was described. That is, only the (b) molding of the first elastomer was described in FIG. 1. However, as shown in FIG. 1(c), multi-color molding performing molding of the second elastomer in parallel with molding of the first elastomer is of course possible. Further, multi-color molding performing molding of a plurality of elastomers such as molding of a third elastomer, molding of a fourth elastomer, . . . is of course possible. In this case, a plurality of compact injection molding units can be built in the mold.

By doing so, it is possible to provide a mold apparatus for two-color molding which enables the use of a general-use mold apparatus with a short support sprue and a simple mold structure.

While the present invention has been described with reference to specific embodiments chosen for purpose of illustration, it should be apparent that numerous modifications could be made thereto by those skilled in the art without departing from the basic concept and scope of the present invention.

1. A mold apparatus for integral molding two types of thermoplastic resins to produce a two-color shaped article having a fixed side mold, a movable side mold freely openable and closable with respect to said fixed side mold, and a movable partitioning member which is arranged at least at one of said fixed side mold and said movable side mold and partitions a space for molding the two types of thermoplastic resins into a first space for molding a first thermoplastic resin and a second space for molding a second thermoplastic resin, characterized in that
said mold apparatus has a compact injection molding unit for injecting said first thermoplastic resin built into it, and
a nozzle of said compact injection molding unit is made to directly adjoin said first space.

2. A mold apparatus according to claim 1 characterized in that
said first thermoplastic resin is a soft resin and said second thermoplastic resin is a hard resin, and
said two-color shaped article is comprised of a main part and packing part, said main part is made by said second thermoplastic resin, and said packing part is made by said first thermoplastic resin.

3. A mold apparatus for integral molding a plurality of types of thermoplastic resins to produce a multi-color shaped article characterized by including a mold apparatus of claim 1 or claim 2.
